(19) United States
(12) Patent Application Publication
(10) Pub. No.: US 2026/0237706 A1
(43) Pub. Date: Aug. 13, 2026

(54) HIGH-TEMPERATURE PROTON EXCHANGE MEMBRANE, PREPARATION METHOD AND USE THEREOF

(71) Applicants: INNER MONGOLIA UNIVERSITY OF SCIENCE & TECHNOLOGY, Baotou City (CN); CHINA NORTHERN RE (GROUP) HIGH-TECH CO., LTD., Baotou City (CN)

(72) Inventors: Jinxiao BAO, Baotou City (CN); Huixuan WANG, Baotou City (CN); Gaofei PAN, Baotou City (CN); Qingchun WANG, Baotou City (CN); Weixiang SHANG, Baotou City (CN); Yuwei MA, Baotou City (CN); Fei RUAN, Baotou City (CN); Wenzhi HAI, Baotou City (CN); Guoqi LIU, Baotou City (CN)

(73) Assignees: INNER MONGOLIA UNIVERSITY OF SCIENCE & TECHNOLOGY, Baotou City (CN); CHINA NORTHERN RE (GROUP) HIGH-TECH CO., LTD., Baotou City (CN)

(21) Appl. No.: 19/454,847

(22) Filed: Jan. 21, 2026

(30) Foreign Application Priority Data
Feb. 7, 2025 (CN) 202510140634.5

(51) Int. Cl. H01M 8/1081; B01J 39/04; B01J 39/17; B01J 47/12; C08J 3/21; C08J 5/22; C08K 9/06; H01M 8/10; H01M 8/103; H01M 8/1051

(52) U.S. Cl. CPC H01M 8/1081; B01J 39/04; B01J 39/17; B01J 47/12; C08J 3/212; C08J 5/2256; C08J 5/2287; C08K 9/06; H01M 8/103; H01M 8/1051; C08J 2379/04; H01M 2008/1095

(57) ABSTRACT

Disclosed are a high-temperature proton exchange membrane, a preparation method and use thereof. The preparation method includes: mixing 1-methylimidazole with 3-chloropropyltriethoxysilane, conducting a reaction to obtain 1-methyl-3-[(triethoxysilyl)propyl]imidazole chloride; mixing the 1-methyl-3-[(triethoxysilyl)propyl]imidazole chloride with a suspension of titanium dioxide, and subjecting a resulting mixture to modification to obtain a modified titanium dioxide; and mixing the modified titanium dioxide, a polybenzimidazole powder and a solvent, and casting an obtained mixture on a substrate to obtain the high-temperature proton exchange membrane.

### CROSS REFERENCE TO RELATED APPLICATION

This patent application claims the benefit and priority of Chinese Patent Application No. 202510140634.5 filed with the China National Intellectual Property Administration on Feb. 7, 2025, the disclosure of which is incorporated by reference herein in its entirety as part of the present application.

### TECHNICAL FIELD

The present disclosure relates to the technical field of fuel cells, and in particular to a high-temperature proton exchange membrane, a preparation method and use thereof.

### BACKGROUND

Proton exchange membrane fuel cells (PEMFCs) are widely used as clean energy conversion devices, especially in vehicles and stationery and portable power generation systems. PEMFCs have strong characteristics, such as simple cooling system, easy heat and water management, and pollution-free emission. A proton exchange membrane is an important part in the high-temperature proton exchange membrane fuel cell, which plays a key role, mainly responsible for internal proton transmission and fuel isolation, and could also be used as a barrier to separate raw material gases and products.

At present, polybenzimidazole doped with phosphoric acid has satisfactory performance in medium and high temperature environment, and is widely used and studied in fuel cells. Remarkably, polybenzimidazole doped with phosphoric acid (PA) usually has better performance and stability than other polymer membranes, such as polyimide, polyethersulfone. Because PA is used as proton carrier, so that PA-doped polybenzimidazole could work at high temperature without dehydration. In order to further improve the performance of PA-doped polybenzimidazole membrane, inorganic particles could be doped, but the compatibility between the inorganic particles and an organic matrix is poor, which would reduce the performance of the proton exchange membrane. Therefore, how to improve the compatibility between the inorganic particles and the organic matrix is an urgent problem to be solved.

### SUMMARY

An object of the present disclosure is to provide a high-temperature proton exchange membrane, a preparation method and use thereof, so as to solve the above problems in the existing proton exchange membranes.

To achieve the above objects, the present disclosure provides the following technical solutions:

The present disclosure provides a method for preparing a high-temperature proton exchange membrane, including the following steps:
mixing 1-methylimidazole with 3-chloropropyltriethoxysilane, conducting a reaction to obtain 1-methyl-3-[(triethoxysilyl)propyl]imidazole chloride;
mixing the 1-methyl-3-[(triethoxysilyl)propyl]imidazole chloride with a suspension of titanium dioxide, and subjecting a resulting mixture to modification to obtain a modified titanium dioxide; and mixing the modified titanium dioxide, a polybenzimidazole powder and a solvent, and casting an obtained mixture on a substrate to obtain the high-temperature proton exchange membrane.

In some embodiments, in the method for preparing the high-temperature proton exchange membrane, a volume ratio of the 1-methylimidazole to the 3-chloropropyltriethoxysilane is in a range of 1-3: 4-6.

In some embodiments, in the method for preparing the high-temperature proton exchange membrane, the reaction is conducted at under a protective atmosphere at a temperature of 50° C. to 100° C. for 10 h to 20 h.

In some embodiments, in the method for preparing the high-temperature proton exchange membrane, a mass ratio of the 1-methyl-3-[(triethoxysilyl)propyl]imidazole chloride to the titanium dioxide in the suspension of titanium dioxide is in a range of 1-2: 1-2.

In some embodiments, in the method for preparing the high-temperature proton exchange membrane, the modification is conducted under a protective atmosphere at a temperature of 50° C. to 100° C. for 10 h to 20 h.

In some embodiments, in the method for preparing the high-temperature proton exchange membrane, the mixing the modified titanium dioxide, the polybenzimidazole powder and the solvent is conducted for 10 h to 20 h.

In some embodiments, in the method for preparing the high-temperature proton exchange membrane, a mass of the modified titanium dioxide is 1% to 20% of a mass of the polybenzimidazole powder.

In some embodiments, in the method for preparing the high-temperature proton exchange membrane, after the casting, the method further comprises soaking a resulting system with an alkaline solution and then drying.

The present disclosure also provides a high-temperature proton exchange membrane prepared by the method for preparing the high-temperature proton exchange membrane.

The present disclosure also provides use of the high-temperature proton exchange membrane in fuel cells.

As can be seen from the above technical solutions, compared with the conventional technology, some embodiments of the present disclosure exhibit the following beneficial effects:
(1) In the present disclosure, a casting method is used to prepare a composite membrane of inorganic particles and polybenzimidazole, so that phosphoric acid transfer channels are increased, and porous nanoparticles store phosphoric acid to a greater extent, thereby improving the acid doping level.
(2) In the present disclosure, inorganic nanoparticles are modified with an ionic liquid, and the ionic liquid is combined with hydroxyl groups on the surface of the nanoparticles to form a silicon cross-linked network, which changes the surface energy of the nanoparticles. As a result, the inorganic nanoparticles could be better match with polar and nonpolar groups of polybenzimidazole, improving the surface affinity of the nanoparticles and further reducing the aggregation of the nanoparticles, thereby enabling the nanoparticles to be well compatible with polybenzimidazole, which could effectively improve the properties such as the mechanical properties and open circuit voltage of the proton exchange membrane.
(3) The method of the present disclosure has mild reaction conditions and simple operation steps, and is suitable for industrial production.

### BRIEF DESCRIPTION OF THE DRAWINGS

To more clearly illustrate the technical solutions in the embodiments of the present disclosure or in the prior art, the accompanying drawings required for the embodiments or the description in the prior art will be briefly described below.

FIG. 1A to FIG. 1J show scanning electron microscope (SEM) images of the high-temperature proton exchange membranes prepared in Examples 1-4 and Comparative example 1; where FIG. 1A is an SEM image of the surface of the high-temperature proton exchange membrane prepared in Comparative example 1, FIG. 1B) is an SEM image of the surface of the high-temperature proton exchange membrane prepared in Example 1, FIG. 1C is an SEM image of the surface of the high-temperature proton exchange membrane prepared in Example 2. FIG. 1D is an SEM image of the surface of the high-temperature proton exchange membrane prepared in Example 3, FIG. 1E is an SEM image of the surface of the high-temperature proton exchange membrane prepared in Example 4, FIG. 1F is an SEM image of the cross-section of the high-temperature proton exchange membrane prepared in Comparative example 1, FIG. 1G is an SEM image of the cross-section of the high-temperature proton exchange membrane prepared in Example 1, FIG. 1H is an SEM image of the cross-section of the high-temperature proton exchange membrane prepared in Example 2, FIG. 1I is an SEM image of the cross-section of the high-temperature proton exchange membrane prepared in Example 3, and FIG. 1J is an SEM image of the cross-section of the high-temperature proton exchange membrane prepared in Example 4;

FIG. 2 shows acid doping level results of the high-temperature proton exchange membranes prepared in Examples 1-4 and Comparative Example 1;

FIG. 3 shows electrical conductivity results of the high-temperature proton exchange membranes prepared in Examples 1-4 and Comparative Example 1;

FIG. 4 shows performance test results of single fuel cells made of high-temperature proton exchange membranes prepared in Examples 1-4 and Comparative Example 1; and

FIG. 5 shows long-term stability results of a single fuel cell made of the high-temperature proton exchange membrane prepared in Example 3.

### DETAILED DESCRIPTION OF THE EMBODIMENTS

The present disclosure provides a method for preparing a high-temperature proton exchange membrane, including the following steps:
mixing 1-methylimidazole with 3-chloropropyltriethoxysilane, and conducting a reaction to obtain 1-methyl-3-[(triethoxysilyl)propyl]imidazole chloride;
mixing the 1-methyl-3-[(triethoxysilyl)propyl]imidazole chloride with a suspension of titanium dioxide, and subjecting a resulting mixture to modification to obtain a modified titanium dioxide; and
mixing the modified titanium dioxide, a polybenzimidazole powder and a solvent, and casting an obtained mixture on a substrate to obtain the high-temperature proton exchange membrane.

In some embodiments of the present disclosure, a volume ratio of the 1-methylimidazole to the 3-chloropropyltriethoxysilane is in a range of 1-3: 4-6, preferably 1-2: 4-5, and further preferably 1:4.

In some embodiments of the present disclosure, the reaction is conducted under a protective atmosphere at a temperature of 50° C. to 100° C., preferably 80° C. to 100° C., and further preferably 100° C. In some embodiments, and the reaction is conducted at for 10 h to 20 h, preferably 15 h to 20 h, and further preferably 20 h.

In some embodiments of the present disclosure, after the reaction is completed, the method further includes centrifugation, washing and vacuum drying.

In some embodiments of the present disclosure, the washing is conducted 2 times with diethyl ether. In some embodiments, the vacuum drying is conducted at a temperature of 50° C. to 100° C., preferably 80° C. to 100° C., and further preferably 100° C. In some embodiments, the vacuum drying is conducted for 10 h to 20 h, preferably 15 h to 20 h, and further preferably 20 h.

In some embodiments of the present disclosure, a mass ratio of the 1-methyl-3-[(triethoxysilyl)propyl]imidazole chloride to the titanium dioxide in the suspension of titanium dioxide is in a range of 1-2: 1-2, preferably 1:1-2, and further preferably 1:2.

In some embodiments of the present disclosure, the titanium dioxide is nanoscale titanium dioxide P25 (P25).

In some embodiments of the present disclosure, the suspension of titanium dioxide is a suspension of titanium dioxide in chloroform. In some embodiments, a ratio of a mass of the titanium dioxide to a volume of the chloroform is in a range of 1 g to 2 g: 20 mL to 100 mL, preferably 1 g to 2 g: 50 mL, and further preferably 1.5 g: 50 mL.

In some embodiments of the present disclosure, the modification is conducted under a protective atmosphere at a temperature of 50° C. to 100° C., preferably 80° C. to 100° C., and further preferably 100° C. In some embodiments, the modification is conducted at for 10 h to 20 h, preferably 15 h to 20 h, and further preferably 20 h.

In some embodiments of the present disclosure, the mixing the modified titanium dioxide, the polybenzimidazole powder and the solvent is conducted for 10 h to 20 h, preferably 15 h to 20 h, and further preferably 20 h.

In the present disclosure, the process for mixing the modified titanium dioxide, the polybenzimidazole powder and the solvent includes: dissolving the polybenzimidazole powder in the solvent and adding the modified titanium dioxide.

In some embodiments of the present disclosure, the solvent is N,N-dimethylacetamide (DMAC).

In some embodiments of the present disclosure, a mass of the modified titanium dioxide is 1% to 20%, preferably 5% to 20%, and further preferably 15% of a mass of the polybenzimidazole powder.

In some embodiments of the present disclosure, a ratio of a total mass of the modified titanium dioxide and the polybenzimidazole powder to a volume of the solvent is in a range of 0.3 g to 1 g: 5 mL, preferably 0.3 g to 0.5 g: 5 mL, and further preferably 0.4 g: 5 mL.

In some embodiments of the present disclosure, the substrate is a glass plate.

In the present disclosure, after the casting, the method further includes soaking with an alkaline solution and then drying.

In some embodiments of the present disclosure, the alkaline solution is 1.15 mol/L of NaOH solution. In some embodiments, the soaking is conducted for 10 h to 20 h, preferably 15 h to 20 h, and further preferably 20 h.

In some embodiments of the present disclosure, the drying is conducted at a temperature of 50° C. to 100° C., preferably 80° C. to 100° C., and further preferably 100° C. In some embodiments, the drying is conducted for 10 h to 20 h, preferably 15 h to 20 h, and further preferably 20 h.

The present disclosure also provides a high-temperature proton exchange membrane prepared by the method for preparing a high-temperature proton exchange membrane as mentioned above.

The present disclosure also provides use of the high-temperature proton exchange membrane in fuel cells.

The technical solutions in the examples of the present disclosure will be described clearly and completely below. Apparently, the described examples are only some of, rather than all of, the examples of the present disclosure. On the basis of the examples in the present disclosure, all the other examples that would have been obtained by those of ordinary skill in the art without involving any creative effort shall fall within the scope of the present disclosure.

### Example 1

This example provided a high-temperature proton exchange membrane, and a method for preparing the same was conducted by the following steps:
(1) 5 mL of 1-methylimidazole and 20 mL of 3-chloropropyltriethoxysilane were subjected to a reaction whiling heating for 20 h at 100° C. under a nitrogen atmosphere. A resulting reaction solution was subjected to centrifuging, washing 2 times with diethyl ether, and then vacuum drying at 100° C. for 20 h to obtain 1-methyl-3-[(triethoxysilyl)propyl]imidazole chloride.
(2) 1.5 g of the 1-methyl-3-[(triethoxysilyl)propyl]imidazole chloride was added to a suspension of 3 g of P 25 in 100 mL of chloroform, and then subjected to a reaction while heating for 20 h at 100° C. under nitrogen atmosphere. A resulting reaction product was subjected to centrifuging and washing with chloroform to remove unreacted 1-methyl-3-[(triethoxysilyl)propyl]imidazole chloride to obtain a modified P25.
(3) Polybenzimidazole (PBI) powder was dissolved in DMAC, and the modified P25 was added thereto. A ratio of a total mass of the PBI powder and the modified P25 to an amount of the DMAC was 0.4 g: 5 mL, and a mass of the modified P25 is 5% of a mass of the PBI powder. An obtained mixture was subjected to magnetic stirring for 20 h at ambient temperature to obtain a mixed solution.
(4) The mixed solution was evenly casted on a glass plate, and a resulting system was subjected to soaking in 1.15 mol/L of NaOH solution for 20 h, and then drying at 100° C. for 20 h to obtain a high-temperature proton exchange membrane with a thickness of 5 μm.

### Example 2

This example provided a method for preparing a high-temperature proton exchange membrane, see Example 1 for details, except that the mass of the modified P25 in step (3) is 10% of the mass of the PBI powder.

### Example 3

This example provided a method for preparing a high-temperature proton exchange membrane, see Example 1 for details, except that the mass of the modified P25 in step (3) is 15% of the mass of the PBI powder.

### Example 4

This example provided a method for preparing a high-temperature proton exchange membrane, see Example 1 for details, except that the mass of the modified P25 in step (3) is 20% of the mass of the PBI powder.

### Comparative Example 1

This Comparative Example provided a method for preparing a high-temperature proton exchange membrane, see example 1 for details, except that it did not contain the modified P25, that is, steps (1)-(2) were not conducted, and the modified P25 was not added in step (3).

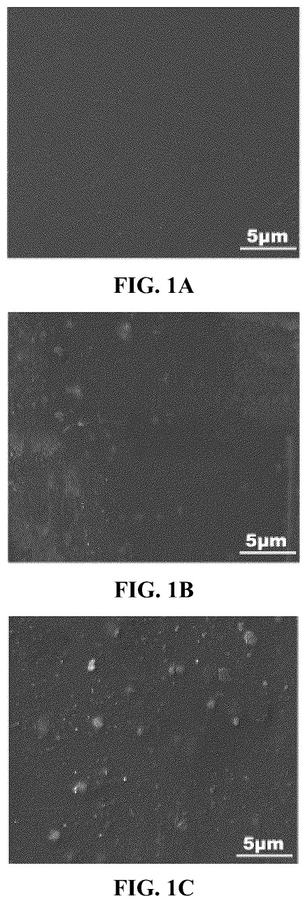

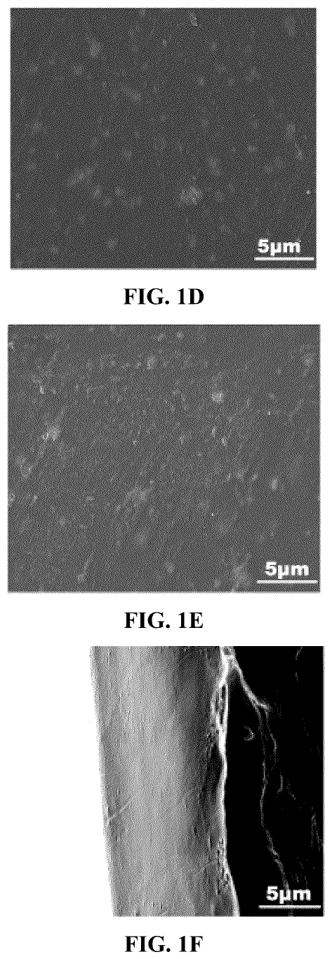

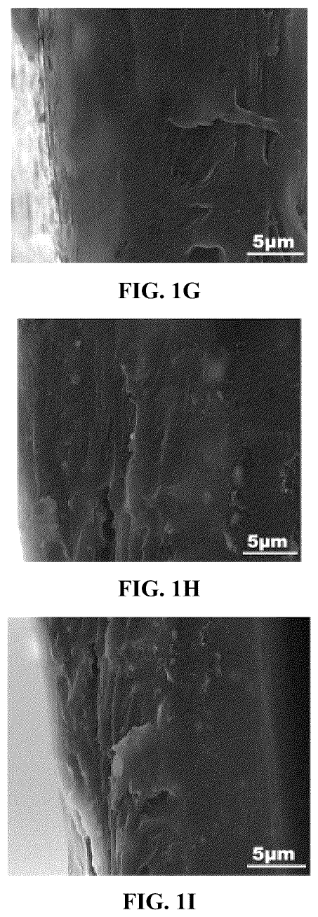

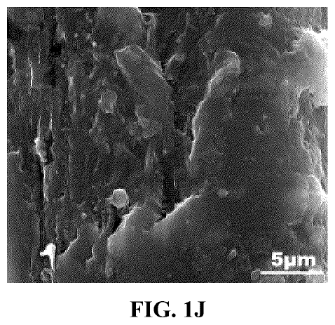

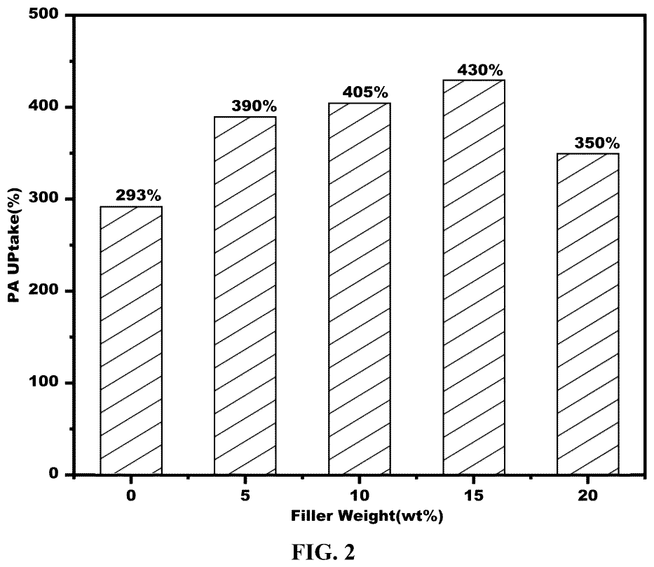

The high-temperature proton exchange membranes of examples 1-4 and Comparative Example 1 were characterized by SEM, and the results are shown in FIG. 1A to FIG. 1J. As can be seen from FIG. 1 A to FIG. 1J, a surface of the membrane without doping nanoparticles is smooth. With the increase of doping amount of nanoparticles, particles appear on the surface of the membrane and increase with the increase of the doping amount, but no cracks and perforations are observed, indicating that nanoparticles have good compatibility with PBI. With the addition of nanoparticles, faults and porosity could be observed in the cross section of the membrane. This is because the nanoparticles destroy the structure between PBI. Consequently, multiple layers in the membrane are formed, which is beneficial to the adsorption and storage of PA.

The high-temperature proton exchange membranes of Examples 1-4 and Comparative Example 1 were soaked in a phosphoric acid solution at a temperature of 50° C. to 100° C. until saturated, and then dried on a glass plate at a temperature of 50° C. to 100° C. for 1 h to 5 h. Subsequent tests of acid doping level, conductivity, single fuel cell performance and long-term stability were conducted.

The method for preparing a single fuel cell was conducted as follows: the high-temperature proton exchange membrane soaked in phosphoric acid was subjected to assembling into a high-temperature fuel cell without back pressure and back humidity. 1 mg cm⁻² Pt/C was used as a gas diffusion electrode, an anode test gase and a cathode test gase were O₂ and H₂. The flow rate of the O₂ was 160 mL min⁻¹, and the flow rate of the H₂ was 80 mL min⁻¹. The test was conducted at 140° C. without water and back pressure.

The acid doping level results of the high-temperature proton exchange membranes of Examples 1-4 and Comparative Example 1 are shown in FIG. 2. As can be seen from FIG. 2, the addition of nanoparticles affects the acid doping level of the composite membrane, and the acid doping level of Examples 1-4 are significantly higher than that in Comparative Example 1. With the increase of the content of nanoparticles, the acid doping level of Examples 1-4 also gradually increases. This is because more nanoparticles absorb PA and have strong affinity for PA. However, when the content of nanoparticles exceeds 20 wt %, the doping level of PA decrease. This is due to the agglomeration of more nanoparticles, which reduces the free volume and inhibits the absorption of PA.

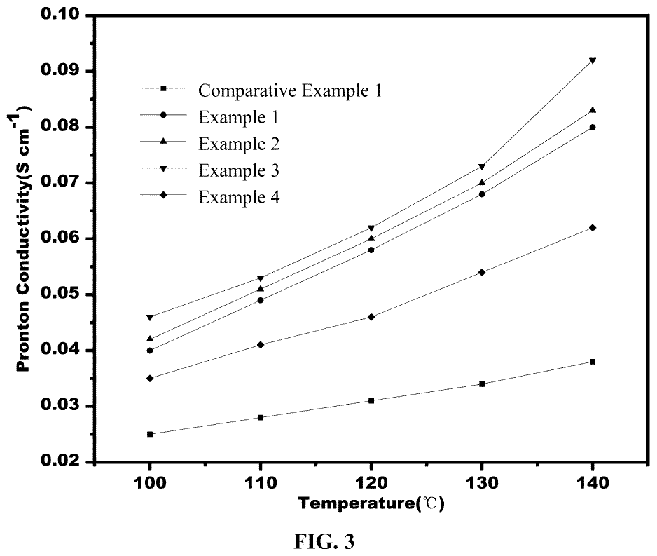

Electrical conductivity results of the high-temperature proton exchange membranes of Examples 1-4 and Comparative Example 1 are shown in FIG. 3. As can be seen from FIG. 3, the proton conductivities of all membranes increase with the increase of temperature, and the proton conductivity of Example 3 is the highest among all membranes at 140° C. The higher proton conductivity was due to the uniform dispersion of nanoparticles, which generates a relatively large specific surface area and consequently greatly adsorbing PA. The proton conductivity of Example 4 decrease due to the discontinuous proton jumping path caused by the aggregation of a large number of nanoparticles that hinder the transport of protons.

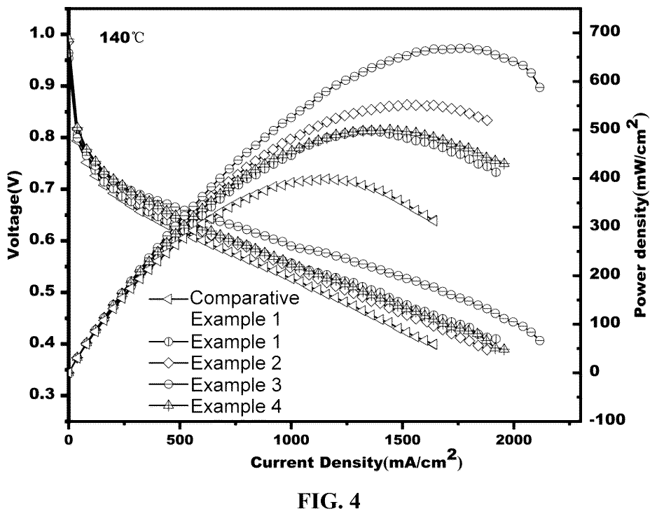

Performance results of single fuel cells made of the high-temperature proton exchange membranes of Examples 1-4 and Comparative Example 1 are shown in FIG. 4. As can be seen from FIG. 4, the maximum power density of Example 3 is 668 mW/cm², and the nanoparticles adsorbe more free PA in the porous structure, and hydrogen bonds are also established to increase proton transfer channels.

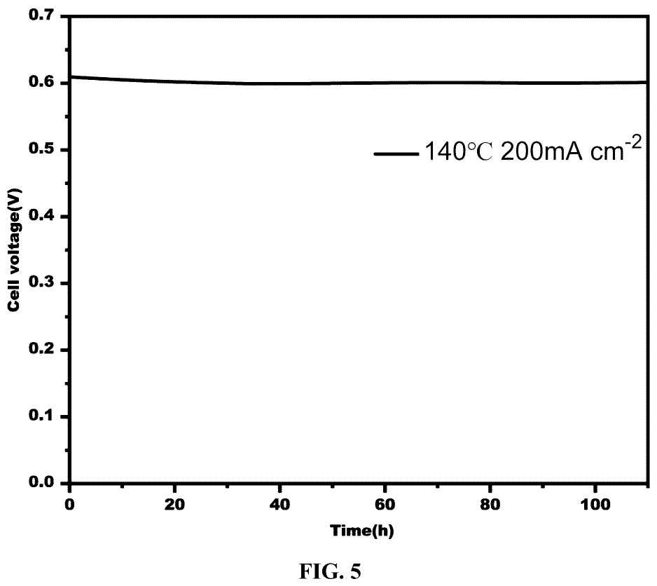

Long-term stability results of a single fuel cell made of the high-temperature proton exchange membrane of Example 3 are shown in FIG. 5. As can be seen from FIG. 5, the voltage drop of Example 3 after 110 h at 140° C. is only 113μV h⁻¹. This is because the leaching of PA leads to the increase of membrane resistance, which hinders the transport of protons.

The descriptions above are merely the preferred embodiments of the present disclosure. It should be noted that several improvements and modifications may also be made by those of ordinary skilled in the art without departing from the principle of the present disclosure, and these improvements and modifications shall also be considered within the scope of the present disclosure.

What is claimed is:

1. A method for preparing a high-temperature proton exchange membrane, comprising the following steps:
mixing 1-methylimidazole with 3-chloropropyltriethoxysilane, and conducting a reaction to obtain 1-methyl-3-[(triethoxysilyl)propyl]imidazole chloride;
mixing the 1-methyl-3-[(triethoxysilyl)propyl]imidazole chloride with a suspension of titanium dioxide, and subjecting a resulting mixture to modification to obtain a modified titanium dioxide; and
mixing the modified titanium dioxide, a polybenzimidazole powder and a solvent, and casting an obtained mixture on a substrate to obtain the high-temperature proton exchange membrane.

2. The method for preparing the high-temperature proton exchange membrane of claim 1, wherein a volume ratio of the 1-methylimidazole to the 3-chloropropyltriethoxysilane is in a range of 1-3: 4-6.

3. The method for preparing the high-temperature proton exchange membrane of claim 2, wherein the reaction is conducted under a protective atmosphere at a temperature of 50° C. to 100° C. for 10 hours (h) to 20 h.

4. The method for preparing the high-temperature proton exchange membrane of claim 1, wherein a mass ratio of the 1-methyl-3-[(triethoxysilyl)propyl]imidazole chloride to the titanium dioxide in the suspension of titanium dioxide is in a range of 1-2: 1-2.

5. The method for preparing the high-temperature proton exchange membrane of claim 4, wherein the modification is conducted under a protective atmosphere at a temperature of 50° C. to 100° C. for 10 h to 20 h.

6. The method for preparing the high-temperature proton exchange membrane of claim 5, wherein the mixing the modified titanium dioxide, the polybenzimidazole powder and the solvent is conducted for 10 h to 20 h.

7. The method for preparing the high-temperature proton exchange membrane of claim 1, wherein a mass of the modified titanium dioxide is 1% to 20% of a mass of the polybenzimidazole powder.

8. The method for preparing the high-temperature proton exchange membrane of claim 7, wherein after the casting, the method further comprises soaking a resulting system with an alkaline solution and then drying.

9. A high-temperature proton exchange membrane prepared by the method for preparing the high-temperature proton exchange membrane of claim 1.

10. The method for preparing the high-temperature proton exchange membrane of claim 2, wherein a mass ratio of the 1-methyl-3-[(triethoxysilyl)propyl]imidazole chloride to the titanium dioxide in the suspension of titanium dioxide is in a range of 1-2: 1-2.

11. The method for preparing the high-temperature proton exchange membrane of claim 5, wherein a mass of the modified titanium dioxide is 1% to 20% of a mass of the polybenzimidazole powder.

12. The method for preparing the high-temperature proton exchange membrane of claim 6, wherein a mass of the modified titanium dioxide is 1% to 20% of a mass of the polybenzimidazole powder.
